(19) United States
(12) Patent Application Publication
(10) Pub. No.: US 2017/0213461 A1
(43) Pub. Date: Jul. 27, 2017

(54) SYSTEM AND METHOD FOR VEHICLE GROUP COMMUNICATION VIA DEDICATED SHORT RANGE COMMUNICATION

(71) Applicant: Ford Global Technologies, LLC, Dearborn, MI (US)

(72) Inventors: Allen R. Murray, Lake Orion, MI (US); Oliver Lei, Windsor (CA)

(21) Appl. No.: 15/003,416

(22) Filed: Jan. 21, 2016

(51) Int. Cl. G08G 1/0967; H04W 4/12; H04W 4/00; H04W 4/04

(52) U.S. Cl. CPC G08G 1/096791; H04W 4/046; H04W 4/12; H04W 4/008

(57) ABSTRACT

Systems and methods for vehicle group communication via dedicated short range communication (DSRC) network are discloses. An example disclosed vehicle includes a DSRC controller configured to communicate with a DSRC network. The example vehicle also includes a processor enabled to execute instructions that cause the vehicle to (a) join a group communication session hosted by the DSRC network, (b) send status messages to other vehicles connected to the group communication session, and (c) inform a driver of traffic information based on the status messages received from the other vehicles.

### TECHNICAL FIELD

The present disclosure generally relates to vehicle communication and, more specifically, systems and methods for vehicle group communication via a dedicated short range communication network.

### BACKGROUND

In the United States, the Dedicated Short Range Communication (DSRC) network is being deployed as a part of the Intelligent Transportation System. The DSRC network will enable to forms of communications: vehicle-to-vehicle (V2V) and vehicle-to-infrastructure (V2I) (collectively V2X). The aim of the DSRC network is to reduce fatalities, injuries, property destruction, time lost in traffic, fuel consumption, among others. Vehicles are being equipped to use the DSRC network.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Exemplary embodiments provide systems and methods for vehicle group communication via a dedicated short range communication network. According to one embodiment, a vehicle includes a DSRC controller configured to communicate with a DSRC network. The example vehicle also includes a processor enabled to execute instructions that cause the vehicle to (a) join a group communication session hosted by the DSRC network, (b) send status messages to other vehicles connected to the group communication session, and (c) inform a driver of traffic information based on the status messages received from the other vehicles In some example embodiments, processor is enabled to execute instructions that cause the vehicle to send chat messages to the other vehicles connected to the group communication session, and inform the driver of the chat messages received from the other vehicles.

According to another embodiment, an example method of vehicle group communication includes joining a group communication session hosted by the DSRC network. The example method also includes sending status messages to other vehicles connected to the group communication session. Additionally, the example method includes informing a driver of traffic information based on the status messages received from the other vehicles.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates a top view of vehicles participating in group communication via a Dedicated Short Range Communication (DSRC) network.

FIG. 2 is a block diagram illustrating electronic components of the vehicles of FIG. 1.

FIG. 3 illustrates vehicles participating in group communication via the DSRC network.

FIG. 4 depicts an example group communication interface displayed by the infotainment head unit when the vehicle is connected to a group communication session.

FIG. 5 is a flowchart of an example method of participating in group communication.

FIG. 6 is a flowchart of an example method of facilitating the group communication session via the DSRC network.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”.

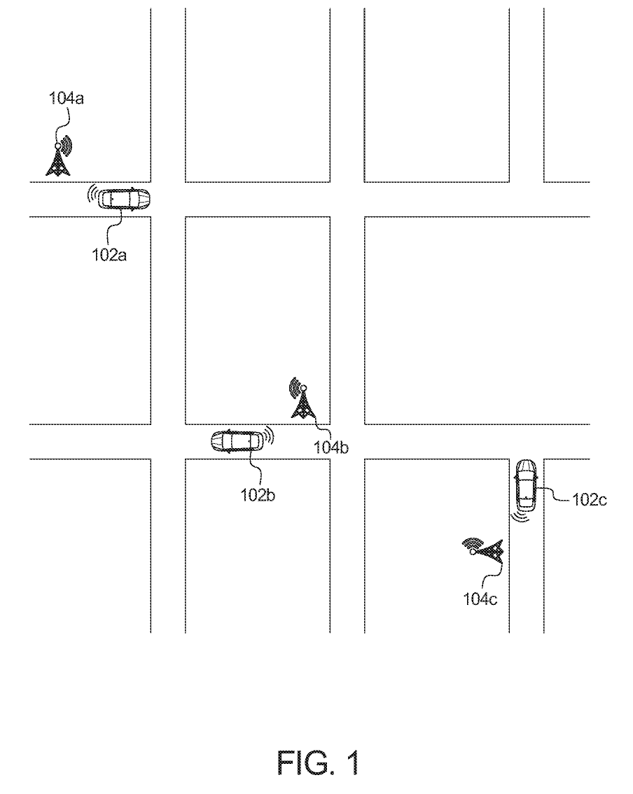

FIG. 1 illustrates a top view of vehicles participating in group communication sessions via a Dedicated Short Range Communication (DSRC) network. In the example illustrated of FIG. 1, connected vehicles 102a, 102b, 102c are communicatively coupled to DSRC transponders 104a, 104b, 104c. The DSRC transponders 104a, 104b, 104c are connected to a DSRC network which facilitates the connected vehicles 102a, 102b, 102c exchanging information in group communication sessions. For example, the connected vehicles 102a, 102b, 102c in the group communication session may exchange traffic information and chat messages.

As used herein, the connected vehicles 102a, 102b, 102c are any vehicles (e.g., cars, trucks, motorcycles, mopeds, etc.) that have a radio and/or software configured to connect to the DSRC transponders 104a, 104b, 104c to communicate over the DSRC network. The connected vehicles 102a, 102b, 102c may be standard gasoline powered vehicles, hybrid vehicles, electric vehicles, fuel cell vehicles, or any other type of suitable vehicles. The connected vehicles 102a, 102b, 102c include standard features (not shown) such as a dashboard, adjustable seats, one or more batteries, an engine or motor, a transmission, an HVAC system including a compressor and electronic expansion valve, a windshield, doors, windows, seatbelts, airbags, and tires.

The example connected vehicles 102a, 102b, 102c exhibit vehicle characteristics and driving properties. The vehicles characteristics include fixed or constant features of the vehicle, such as its acceleration capacity, braking capacity, vehicle communication capability (e.g., DSRC communication, cellular communication, local are wireless network communication, etc.), size, weight, etc. The driving properties include variable features of the vehicle, such as its position or location, speed, acceleration, decelerating, level of fuel, and current activity of its lights or horn.

The example DSRC transponders 104a, 104b, 104c are installed near driving infrastructure (e.g., streets, highways, tunnels, bridges, interstates, etc.) to facilitate the connected vehicles 102a, 102b, 102c to communicate with each other while geographically separated. The DSRC transponders 104a, 104b, 104c include antenna(s), radio(s) and software to establish and maintain DSRC connections with the connected vehicles 102a, 102b, 102c. DSRC is a wireless communication protocol or system, mainly meant for transportation, operating in a 5.9 GHz spectrum band. More information on the DSRC network and how the network may communicate with vehicle hardware and software is available in the U.S. Department of Transportation's Core June 2011 System Requirements Specification (SyRS) report (available at http://www.its.dot.gov/meetings/pdf/CoreSystem_SE_SyRS_RevA %20(2011-06-13).pdf), which is hereby incorporated by reference in its entirety along with all of the documents referenced on pages 11 to 14 of the SyRS report. DSRC systems may be installed on vehicles and along roadsides on infrastructure. DSRC systems incorporating infrastructure information is known as a “roadside” system. DSRC may be combined with other technologies, such as Global Position System (GPS), Visual Light Communications (VLC), Cellular Communications, and short range radar, facilitating the vehicles communicating their position, speed, heading, relative position to other objects and to exchange information with other vehicles or external computer systems. DSRC systems can be integrated with other systems such as mobile phones.

Currently, the DSRC network is identified under the DSRC abbreviation or name. However, other names are sometimes used, usually related to a Connected Vehicle program or the like. Most of these systems are either pure DSRC or a variation of the IEEE 802.11 wireless standard. The term DSRC will be used throughout herein. However, besides the pure DSRC system it is also meant to cover dedicated wireless communication systems between cars and roadside infrastructure system, which are integrated with GPS and are based on an IEEE 802.11 protocol for wireless local area networks (such as 802.11p).

In the example illustrated in FIG. 1, the example DSRC transponders 104a, 104b, 104c are wired and/or wirelessly connected to server(s) to establish the DSRC network. The DSRC network facilitates group communication between the connected vehicle 102a, 102b, 102c by, for example, establishing and maintaining the group communication sessions, receiving messages from one of the connected vehicle 102a, 102b, 102c, and routing the messages to the other connected vehicle 102a, 102b, 102c in the group communication session.

The DSRC transponders 104a, 104b, 104c implementing DSRC have a range of 300 meters (984 feet) to 1000 meters (3280 feet). When one of the connected vehicles 102a, 102b, 102c enters the range of one of the DSRC transponders 104a, 104b, 104c, the connected vehicle 102a, 102b, 102c registers with the corresponding DSRC transponder 104a, 104b, 104c. In such a manner, as the connected vehicle 102a, 102b, 102c travels along the driving infrastructure, the connected vehicle 102a, 102b, 102c remains communicatively coupled to the DSRC network.

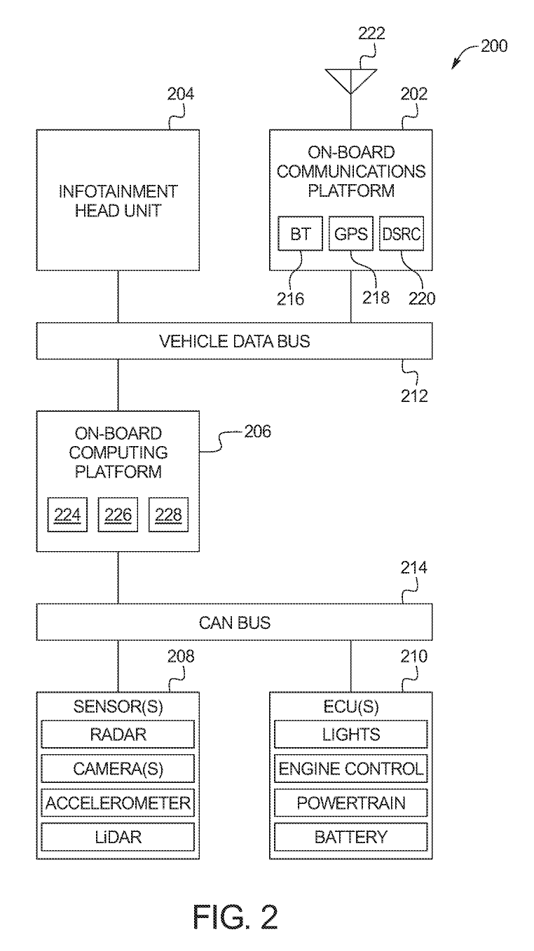

FIG. 2 is a block diagram illustrating electronic components 200 of the connected vehicles 102a, 102b, 102c of FIG. 1. The electronic components 200 include an example on-board communications platform 202, an example infotainment head unit 204, an on-board computing platform 206, example sensors 208, example electronic control units (ECUs) 210, an example vehicle data bus 212, and an example controller area network (CAN) bus 214.

The on-board communications platform 202 includes wired or wireless network interfaces to enable communication with external networks. The on-board communications platform 202 also includes hardware (e.g., processors, memory, storage, antenna, etc.) and software to control the wired or wireless network interfaces. In the illustrated example, the on-board communications platform 202 includes a Bluetooth® controller 216, a GPS receiver 218, and a DSRC controller 220. The on-board communications platform 202 may also include controllers for other standards-based networks (e.g., Global System for Mobile Communications (GSM), Universal Mobile Telecommunications System (UMTS), Long Term Evolution (LTE), Code Division Multiple Access (CDMA), WiMAX (IEEE 802.16m); Near Field Communication (NFC); local area wireless network (including IEEE 802.11 a/b/g/n/ac or others), and Wireless Gigabit (IEEE 802.11ad), etc.). Further, the external network(s) may be a public network, such as the Internet; a private network, such as an intranet; or combinations thereof, and may utilize a variety of networking protocols now available or later developed including, but not limited to, TCP/IP-based networking protocols. The on-board communications platform 202 may also include a wired or wireless interface to enable direct communication with an electronic device.

The DSRC controller 220 is communicatively coupled to an antenna 222. The antenna 22 is configured to send and receive message in accordance with DSRC. The DSRC controller 220 manages sending and receiving messages between the vehicles 102a, 102b, 102c and the DSRC transponders 104a, 104b, 104c in accordance with DSRC. For example, the on-board computing platform 206 may instruct the DSRC controller 220 to send a particular message to the appropriate DSRC transponder 104a, 104b, 104c

The infotainment head unit 204 provides an interface between the connected vehicle 102a, 102b, 102c and a user (e.g., a driver, a passenger, etc.). The infotainment head unit 204 includes digital and/or analog controls (e.g., input devices and output devices) to receive input from the user(s) and display information. The input devices may include, for example, a control knob, an instrument panel, a digital camera for image capture and/or visual command recognition, a touch screen, an audio input device (e.g., cabin microphone), buttons, or a touchpad. The output devices may include instrument cluster outputs (e.g., dials, lighting devices), actuators, a display (e.g., a liquid crystal display (“LCD”), an organic light emitting diode (“OLED”) display, a flat panel display, a solid state display, or a heads-up display), and speakers.

The on-board computing platform 206 includes a processor or controller 224, memory 226, and storage 228. The processor or controller 224 may be any suitable processing device or set of processing devices such as, but not limited to: a microprocessor, a microcontroller-based platform, a suitable integrated circuit, or one or more application-specific integrated circuits (ASICs). The memory 226 may be volatile memory (e.g., RAM, which can include non-volatile RAM, magnetic RAM, ferroelectric RAM, and any other suitable forms); non-volatile memory (e.g., disk memory, FLASH memory, EPROMs, EEPROMs, memristor-based non-volatile solid-state memory, etc.), unalterable memory (e.g., EPROMs), and read-only memory. In some examples, the memory 226 includes multiple kinds of memory, particularly volatile memory add non-volatile memory. The storage 228 may include a hard drive; a solid state hard drive; or a physical disk such as a DVD.

The memory 226 and the storage 228 are a computer readable medium on which one or more sets of instructions, such as the software for operating the methods of the present disclosure can be embedded. The instructions may embody one or more of the methods or logic as described herein. In a particular embodiment, the instructions may reside completely, or at least partially, within any one or more of the memory 226, the computer readable medium, and/or within the processor 224 during execution of the instructions.

The term “computer-readable medium” should be understood to include a single medium or multiple media, such as a centralized or distributed database, and/or associated caches and servers that store one or more sets of instructions. The term “computer-readable medium” also includes any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

The sensors 208 may be arranged in and around the connected vehicle 102a, 102b, 102c in any suitable fashion. The sensors 208 may include camera(s), sonar, LiDAR, radar, optical sensors, or infrared devices configured to measure properties around the exterior of the connected vehicle 102a, 102b, 102c. Additionally, some sensors 208 may be mounted inside the passenger compartment of the connected vehicle 102a, 102b, 102c or in the engine compartment of the connected vehicle 102a, 102b, 102c to measure properties in the interior of the connected vehicle 102a, 102b, 102c. For example, such sensors 208 may include accelerometers, odometers, cameras, microphones, and thermistors, etc.

The ECUs 210 monitor and control the low-level systems of the connected vehicle 102a, 102b, 102c. For example, the ECUs 210 may control and/or monitor the lighting system, the engine, the power locks, the power windows, the power train, the HVAC system, and the battery management, etc. The ECU(s) communicate properties to and/or receive commands from the on-board computing platform 206.

The vehicle data bus 212 communicatively couples the on-board communications platform 202, the infotainment head unit 204, and the on-board computing platform 206. The vehicle data bus 212 may be an Ethernet network. The CAN bus 214 communicatively couples the sensors 208, the ECUs 210, and the on-board computing platform 206. The CAN bus protocol is defined by International Standards Organization (ISO) 11898-1. In some examples, the on-board computing platform 206 communicatively isolates the vehicle data bus 212 and the CAN bus 214 (e.g., via firewalls, message brokers, etc.). Alternatively, in some examples, the vehicle data bus 212 and the CAN bus 214 may be the same data bus.

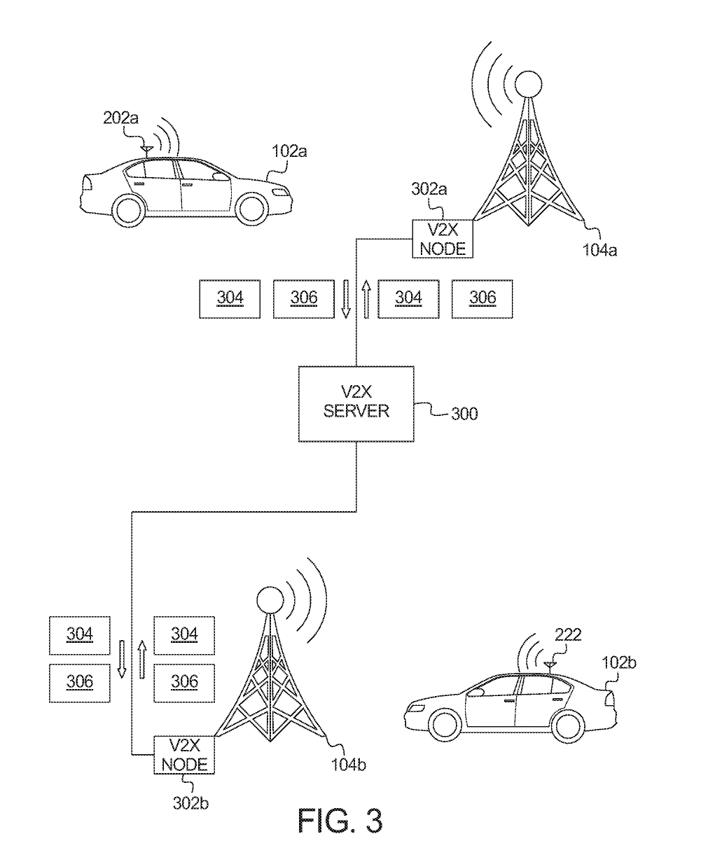

FIG. 3 illustrates connected vehicles 102a, 102b participating in group communication via the DSRC network. In the illustrated example, a DSRC server 300 facilitates group communication sessions between the connected vehicles 102a, 102b. The connected vehicles 102a, 102b are associated with vehicle identifiers (VIDs) that uniquely identify the particular connected vehicle 102a, 102b. Individual users (e.g., drivers, passengers, etc.) are associated with user identifiers (UIDs) that uniquely identify the particular individual.

To initiate a group communication session, the user sends a request to the DSRC server 300 (e.g., via a touch screen of the infotainment head unit 204 of FIG. 2) through an application executing on the on-board computing platform 206. For example the driver of the first connected vehicle 102a may request that a new group communication session be established. The connected vehicle 102a sends the request, the VID and the UID associated with the user to the DSRC server 300 via the transponder 104a. The DSRC server 300 creates the group communication session. The DSRC server 300 also assigns a session identifier (SID) to the group communication session or the driver specifies a SID. The SID can be a number or meaningful words or number-alphabet combination that uniquely identified the group communication session. The user that requested the group communication session may share the SID with others (e.g., friends, family, coworkers, etc.).

To connect to the group communication session, the user uses the corresponding SID (e.g., via a touch screen of the infotainment head unit 204 of FIG. 2) through the application executing on the on-board computing platform 206. For example, the driver of a second connected vehicle 102b may use the SID of the group communication session initiated by driver of the first connected vehicle 102a. The connected vehicle 102b sends the SID, the VID and the UID to the DSRC server 300 via the transponder 104b. The connected vehicle 102a, 102b may be connected to multiple group communication sessions.

The group communication sessions may be temporary or may be permanent. If the group communication session is temporary, the group communication session terminates when the connected vehicles 102a, 102b disconnect from the DSRC network. If the group communication session is permanent, the group communication session is persistent even when no connected vehicles 102a, 102b are currently connected. In such a manner, the connected vehicle 102a, 102b may connect to the same group communication session using the same SID over time. In some examples, the DSRC server 300 remembers UIDs that are associated (e.g., previously joined) with SIDs. In some such examples, when the connect vehicle 102a, 102b connects to the DSRC network with the UID, the connected vehicle 102a, 102b may automatically join previous group communication sessions.

When the connected vehicle 102a, 102b comes in range of one of the DSRC transponders 104a, 104b, the connect vehicle 102a, 102b registers with a DSRC node 302a, 302b corresponding to the in-range DSRC transponder 104a, 104b. The DSRC server 300 maintains a lookup table that associates the VID of connect vehicle 102a, 102b with corresponding the DSRC node 302a, 302b. In such a manner, the DSRC server 300 knows the location of all the connected vehicles 102a, 102b, and can send messages from the group communication session to the connect vehicle 102a, 102b as the connect vehicle 102a, 102b travels around a geographical area.

When the connected vehicle 102a, 102b is connected to a group communication session, the connected vehicle 102a, 102b sends status messages 304 and chat messages 306. The connected vehicle 102a, 102b sends the status messages 304 from time to time (e.g., every thirty seconds, every sixty seconds, etc.). The status messages 304 include driving properties (e.g. location, speed, etc.). For example, the status message 304 may include that the connected vehicle 102a, 102b is moving at two miles per hour. In some examples, the status message 304 includes a travel time spent traveling through/across a particular geographic feature (e.g., a bridge, a tunnel, a board control station, etc.). For example, the connected vehicle 102a, 102b may track when it starts crossing the Ambassador International Bridge and when it exits the bridge. In some examples, the status messages 304 also include an image and/or a video of surrounded traffic conditions. The information included in the status message 304 may be gathered from the sensor(s) 208 and/or the ECU(s) 210 of FIG. 2.

The chat messages 306 include information as directed by the user. In some examples, the chat messages 306 include voice, text, video, and/or music, etc. For example, the chat message 306 may include the text, “The tunnel is really backed up today.” The configurable messages 306 are sent when the user directs them to be sent. In such a manner, the connected vehicle 102a, 102b connected to the group communication session can participate in a group conversation. The chat messages 306 may also include notifications. For example, the chat messages 306 may announce when a new connected vehicle 102a, 102b has connected to the group chat session.

The DSRC server 300 receives the status messages 304 and the chat messages 306. The DSRC server 300 sends the messages 304, 306 to the connected vehicles 102a, 102b connected to the corresponding group communications session. For example, if the status message 304 is sent by the first connected vehicle 102a, the DSRC server 300 sends the status message 304 to the second connected vehicle 102b.

When the connected vehicle 102a, 102b receives the status message 304, the connected vehicle 102a, 102b interprets the driving properties included in the status message 304 to inform the user of traffic conditions. For example, if the status message 304 indicates that the sender is moving at a speed of two miles per hour at a particular location, the connected vehicle 102a, 102b may display a red bar at the location on a map (e.g., via the infotainment head unit 204).

When the connected vehicle 102a, 102b receives the chat message 306, the connected vehicle 102a, 102b displays and/or plays the contents of the configurable message (e.g., via the infotainment head unit 204). In some examples, the connected vehicle 102a, 102b includes a text-to-voice function to play text included in the chat message 306.

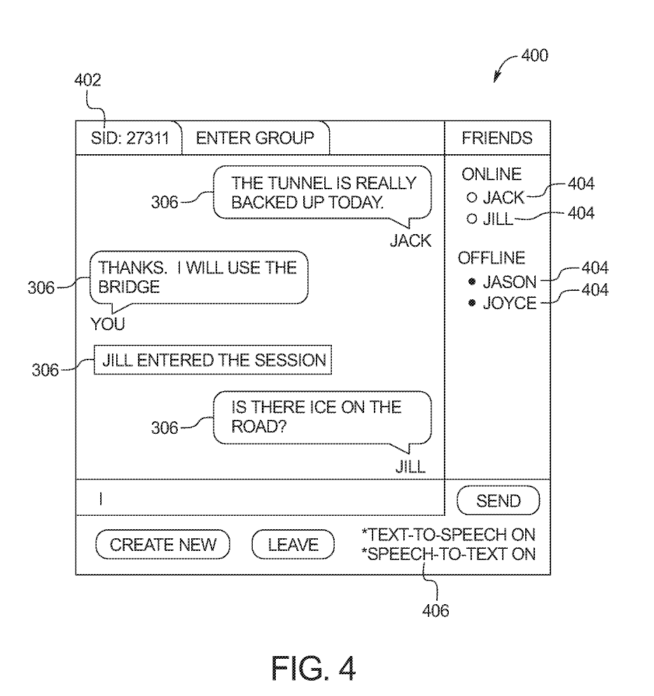

FIG. 4 depicts an example group communication interface 400 displayed by the infotainment head unit 204 of FIG. 2 when the connected vehicle 102a, 102b, 102c is connected to the group communication session. In the illustrated example, the group communication interface 400 displays the SID 402 corresponding to the group communication session. The group communication interface 400 also displays the corresponding chat messages 306. The group communication interface 400 also displays the UIDs 404 of users associated with the SID 402 and their status (e.g., online, offline, etc.). The group communication interface 400 facilitates connecting to existing group communication sessions, creating new group communication sessions, and leaving the group communication sessions. The group communication interface 400 also displays options 406 that are enabled and/or disabled. For example, the options 406 may indicate that text-to-speech and speech-to-text options are enabled.

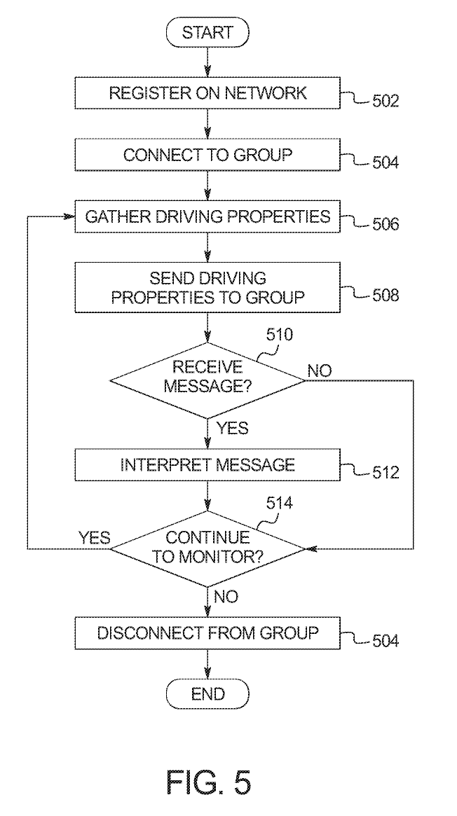

FIG. 5 is a flowchart of an example method of participating in group communication. Initially, the DSRC controller 220 of the connected vehicle 102a, 102b, 102c registers with the DSRC network (block 502). For example, the DSRC controller 220 may send a registration message that is received by the closest DSRC transponder 104a, 104b, 104c so that the DSRC server 300 can update the DSRC lookup table. The connected vehicle 102a, 102b, 102c, via the DSRC controller 220, connects to a group communication session (block 504). For example, the DSRC controller 220 may send the SID of the group communication session to be joined.

The connected vehicle 102a, 102b, 102c, via the on-board computing platform 206, gathers the driving properties (block 506). For example, the connected vehicle 102a, 102b, 102c may gather the speed (e.g., via the sensors 208), the location (e.g., via the GPS receiver 218) of the connected vehicle 102a, 102b, 102c, and/or data from the other sensors 208 and/or the ECUs 210. In some example embodiments, the drive properties include travel time to travel across/through a segment of infrastructure (e.g., a bridge, a tunnel, a border crossing, a segment of highway, etc.). The connected vehicle 102a, 102b, 102c may also use the cameras to capture a video/image surrounding the connected vehicle 102a, 102b, 102c. The connected vehicle 102a, 102b, 102c, via the DSRC controller 220, sends the status message 304 including the driving properties to the DSRC server 300 (block 508). In some examples, the connected vehicle 102a, 102b, 102c also sends the chat message 306 generated by the user via the infotainment head unit 204. The connected vehicle 102a, 102b, 102c may send the chat messages 306 periodically or when the driver manually triggers sending the message 306.

The connected vehicle 102a, 102b, 102c determines whether the status message 304 and/or the chat message 304 has been received from the DSRC server 300 (block 510). If the status message 304 and/or the chat message 304 has been received, connected vehicle 102a, 102b, 102c, via the on-board computing platform 206, interprets the message (block 512). For example, the on-board computing platform 206 may display and/or play the chat message 306 via the infotainment head unit 204. As another example, the on-board computing platform 206 may use the speed data and the location data from the status message 304 to infer traffic conditions near the location, and display the traffic information on the map of the navigation system. The connected vehicle 102a, 102b, 102c may also display other group vehicles status (such as ON or OFF) based on the registration status received from the DSRC server 300.

The connected vehicle 102a, 102b, 102c, via the on-board computing platform 206, determines whether to continue monitoring the driving properties (e.g. for the status messages 304) and/or the group communication interface 400 (e.g., for the chat message 306) (block 514). For example, if the ignition of the connected vehicle 102a, 102b, 102c is switched to “OFF” or the user has indicated to disconnect, the on-board computing platform 206 may determine not to continue to monitor. If the on-board computing platform 206 determines to continue to monitor, the connected vehicle 102a, 102b, 102c, via the on-board computing platform 206, gathers the driving properties (block 506). Otherwise, if the on-board computing platform 206 determines not to continue to monitor, the DSRC controller 220 sends a message to the DSRC server 300 to disconnect from the group communication session (block 516). The example method of FIG. 5 then ends.

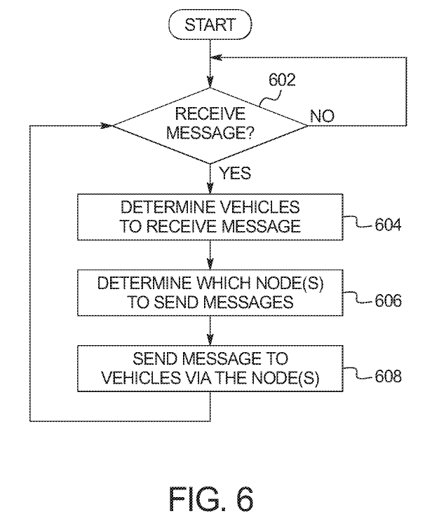

FIG. 6 is a flowchart of an example method of facilitating group communication session via the DSRC network. Initially, the DSRC server 300 waits until the DSRC server 300 receives the status message 204 or the chat message 306 from the connected vehicles 102a, 102b, 102c connected to the DSRC network (block 602). When the status message 204 or the chat message 306 is received, the DSRC server 300 determines which of the connected vehicles 102a, 102b, 102c is/are to receive the status message 204 or the chat message 306 (block 604). For example, the DSRC server 300 may determine which UIDs and/or VIDs are associated with the SID corresponding to the received message.

The DSRC server 300 determines to which DSRC node(s) 302a, 302b that the recipient connected vehicle(s) 102a, 102b, 102c is/are connected (block 606). For example, the DSRC server may use the lookup table established when the connected vehicles 102a, 102b, 102c register with the DSRC network. The DSRC server 300 sends the status message 204 or the chat message 306 to the recipient connected vehicle(s) 102a, 102b, 102c via the corresponding DSRC node(s) 302a, 302b (block 608). The DSRC server 300 then waits until the DSRC server 300 receives the status message 204 or the chat message 306 from the connected vehicles 102a, 102b, 102c connected to the DSRC network (block 602).

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A vehicle comprising:
a DSRC controller configured to communicate with a DSRC network; and
a processor enabled to execute instructions that cause the vehicle to:
join a group communication session hosted by the DSRC network;
send status messages to other vehicles connected to the group communication session;
update traffic information based on the status messages received from the other vehicles.

2. The vehicle of claim 1, wherein the instructions further cause the vehicle to:
send chat messages to the other vehicles connected to the group communication session; and
communicate the chat messages received from the other vehicles.

3. The vehicle of claim 2, wherein the chat messages include at least one of text, an image, a video, or music.

4. The vehicle of claim 2, wherein to communicate the chat messages received from the other vehicles, the instructions cause the vehicle to display the chat messages on a screen of an infotainment head unit.

5. The vehicle of claim 1, wherein the status messages include driving properties of the vehicle.

6. The vehicle of claim 5, wherein the driving properties include at least one of a speed of the vehicle, a location of the vehicle, a travel time of the vehicle, or an image captured by the vehicle.

7. The vehicle of claim 1, wherein to join the group communication session hosted by the DSRC network, the instructions cause the vehicle to send a session identifier to the DSRC network.

8. A method of vehicle group communication, the method comprising:
joining a group communication session hosted by the DSRC network;
sending status messages to other vehicles connected to the group communication session;
updating traffic information based on the status messages received from the other vehicles.

9. The method of claim 8, wherein the method further includes:
sending chat messages to the other vehicles connected to the group communication session; and
communicating the chat messages received from the other vehicles.

10. The method of claim 9, wherein the chat messages include at least one of text, an image, a video, or music.

11. The method of claim 9, wherein communicating the chat messages received from the other vehicles further includes displaying the chat messages on a screen of an infotainment head unit.

12. The method of claim 8, wherein the status messages include driving properties of the vehicle.

13. The method of claim 12, wherein the driving properties include at least one of a speed of the vehicle, a location of the vehicle, a travel time of the vehicle, a video, or an image captured by the vehicle.

14. The method of claim 8, wherein joining the group communication session hosted by the DSRC network further includes sending a session identifier to the DSRC network.

15. A computer readable medium comprising instruction that, when executed, cause a vehicle to:
join a group communication session hosted by the DSRC network;
send status messages to other vehicles connected to the group communication session;
update traffic information based on the status messages received from the other vehicles.

16. The computer readable medium of claim 15, wherein the instruction that, when executed, cause the vehicle to:
send chat messages to the other vehicles connected to the group communication session; and
communicating the chat messages received from the other vehicles.

17. The computer readable medium of claim 16, wherein the chat messages include at least one of text, an image, a video, or music.

18. The computer readable medium of claim 15, wherein the status messages include driving properties of the vehicle.

19. The computer readable medium of claim 18, wherein the driving properties include at least one of a speed of the vehicle, a location of the vehicle, a travel time of the vehicle, a video, or an image captured by the vehicle.

20. The computer readable medium of claim 15, wherein to join the group communication session hosted by the DSRC network, the instructions cause the vehicle to send a session identifier to the DSRC network.
